(19) United States
(12) Patent Application Publication
(10) Pub. No.: US 2008/0112775 A1
(43) Pub. Date: May 15, 2008

(54) Superdrilling Tri-shaft Screw

(76) Inventor: Tai-Ping Hsu, A Lien Hsiang (TW)

Correspondence Address: Dr. BANGER SHIA;Int''l Patent Office of Bang Shia, 102 Lindencrest Ct, Sugar Land, TX, 77479-5201, US

(21) Appl. No.: 11/558,920

(22) Filed: Nov. 12, 2006

(51) Int. Cl. F16B 35/04

(52) U.S. Cl. 411/394

(57) ABSTRACT

A screw with triple regions of shaft provides an optimal drilling/securing power as well as debris-containing capacity. To encompass the above opposing functions in a screw, the middle region is configured in two alternative ways: (1) Both the number of spiral threads per unit length and the outer diameter of spiral threads in the middle region are reduced to create more capacity for debris; and (2) Replace voluminous spiral threads with an equivalent space-saving securing structure of rhombic threads.

### BACKGROUND OF THE INVENTION

1. Field of the Invention

The present invention relates to a screw. In particular, it relates to a tri-region screw with an effective drilling ability and debris removal capacity.

2. Description of Related Art

In general, a wood product is made of a superficial or top level of composite lumber, and an inner level of wood. When a screw is operated, the lower region of a screw drills through the top level of composite lumber before screwing into an inner wood level. At the time the lower region is inside the inner wood level, the upper region of a screw is most likely to be at the top level of composite lumber.

Given the above-described screwing process, two important factors are always considered in designing screws. They are:
(a) the density of spiral threads (i.e. the number of spiral threads per unit length) contained; and
(b) the capacity for containing debris (which are generated during screwing).

The rule of thumbs is that the more closely disposed spiral threads are, the faster screwing speed shall be, and also the more securing a screw will be inside the wood. Nevertheless, the more closely disposed spiral threads are, the less room drilled by a screw is left for debris. As a result, the accumulated or “yet-to-be-digested” debris adversely acts as a resistance to screwing, and thereby slowing down the operation.

To solve the above dilemma between density of spiral threads and capacity for debris, a conventional screw 1 is disclosed in U.S. Pat. No. 6,966,737 and shown in FIG. 1. U.S. Pat. No. 6,966,737 offers a solution to the above dilemma in a divided-in-half approach: the upper region of a screw shaft serves more for securing a screw, while the lower region, more for containing debris, in addition to the default drilling and securing function associated with spiral threads in the two regions.

This divided-in-half approach is realized by reducing the volume of that specific region of a screw shaft specialized more in containing debris, resulting in a non-uniform screw shaft with two regions of different radius and different density of spiral threads disposed thereon. The screw 1 in FIG. 1 comprises more spiral threads per unit length in the upper region, and less spiral threads in the lower region made of smaller radius. In other words, the upper region with dense spiral threads takes more responsibility in locking a screw; while an extra capacity for debris is created by reducing the volume of the lower region as well as the number of spiral threads, as discussed in more details below.

The screw 1 in FIG. 1 includes a head 11 and a shaft 12 connecting to the head 11. The shaft 12 comprises a distal end 121, a 1^{st} thread region 122 and a 2^{nd} thread region 123 spirally disposed thereon, and a cross-sectional area 124 disposed between the 1^{st} thread region 122 and the 2^{nd} thread region 123. The number of threads per unit length in the 2^{nd} thread region 123 exceeds that of the 1^{st} thread region 122.

Having described U.S. Pat. No. 6,966,737, we proceed to summarize some other prior US Patents such as U.S. Pat. No. 7,037,059, Pat. No. 6,666,638, Pat. No. 6,074,149, and Pat. No. 5,816,012. All these four Patents reveal a screw with a three-region shaft (like the present invention). Nevertheless, the middle region disclosed in these patents are merely a section of naked shaft free of spiral threads, serving a single function—a debris container, and hence cannot be counted as an optimal solution to the conventional dilemma between density of spiral threads and debris-containing capacity.

The key to solve the dilemma lies in creating an extra debris capacity at the minimal cost of reducing the numbers of spiral threads which work to drill a hole and to secure the screw in position. It is therefore the purpose of this invention to provide a screw retaining conflicting dual functions, drilling and securing vs. debris-containing capacity, at an optimal level. The screw thus configured is able to drill effectively into the wood (with or without spiral threads), and at the same time, efficiently removes debris upwards by creating an extra space without reducing the number of spiral threads.

### SUMMARY OF THE INVENTION

The present invention strategically solves the above-stated conventional dilemma in designing screws by resorting to:

(1) rhombic threads, a thread-equivalent structure that retains the drilling and locking function of spiral spreads with minimal volume needed; or

(2) diminishing the outer diameter of spiral threads (and hence the volume occupyed by spiral threads) without reducing the number of threads per unit length.

A middle region (or a 3^{rd} region) of a screw shaft in the present invention serves as a balancing point between the conventional dilemma. The middle region in the present invention plays a very different role from prior arts revealing a middle region of a screw shaft free of spiral threads. The middle region in this invention fulfill two essentially opposing functions in one region: drilling or locking vs. debris-containing; while the middle region in the prior arts acts simply as a debris container.

To be more specific, in this invention, the drilling ability of a screw is retained by having a middle region configured with spiral threads of smaller diameter, or alternatively, with an equivalent drilling structure (such as rhombic threads) requiring less volume. Due to the less voluminous rhombic threads or spiral threads of smaller diameter, the debris-containing capacity increases which effectively “digests” or reduces the resistance of debris to drilling, and thereby accelerates the drilling speed. In other words, the 3^{rd} region disposed in between the shaft of a screw functions as a driller, a debris container, and a locker.

Being mainly as a debris container, two restrictions are placed on the configuration of spiral threads in the 3^{rd} region:

(a) The outer diameter of the threads in the 3^{rd} region does not exceed that of the 1^{st} region and the 2^{nd} in order to allow more debris to stay in the 3^{rd} region.

(b) The number of threads per unit length in the 3^{rd} region does not exceed that of its two neighbor regions in order to increase the debris container space.

The screw in accordance with the present invention therefore comprises a head and a shank engaging the head. The shank has a distal end, a 1^{st} region disposed near the distal end, a 2^{nd} region located near said head, and a 3^{rd} region sandwiched between the 1^{st} and the 2^{nd} region. The 3^{rd} region could be implemented either with spiral threads or with rhombic threads, with the latter (i.e. the 3^{rd} region with rhombic threads) allowing for maximal storage room for debris.

The threads of the 1^{st}, 2^{nd}, and 3^{rd} region all spiral in the same direction to facilitate drilling. As the upfront contact point with a wood product, the number of threads per unit length in the 1^{st} region is less than that in the 2^{nd} region for the 1^{st} region to optimally contain or “digest” the debris and reduce the resistance created by debris.

The outer diameter of the 3^{rd} region is smaller than that of the 1^{st} and 2^{nd} region, creating a spacious container for the waste product of debris moving upwards from the 1^{st} region. As a result, the resistance to drilling is effectively reduced, and the screwing action is accelerated.

The 2^{nd} region, interfacing directly with the outside, is designed with the most number of threads per unit length to ensure securing of the screw inside the wood product.

The advantages of the present invention over the known prior arts is capitulated as follows:
(1) The present invention, a tri-region screw, differs from U.S. Pat. No. 6,966,737 (a dual-region screw) in that the present invention increases the debris container space without changing the size (or radius) of the screw shaft. Instead, it simply reduces the diameters of spiral threads in the middle region. Or alternatively, it replaces the voluminous spiral threads with volume-saving rhombic spreads.
(2) It differs from U.S. Pat. No. 7,037,059, Pat. No. 6,666,638, Pat. No. 6,074,149, Pat. No. 5,816,012 (all of which are tri-region screws) in that the 3^{rd} region (or the middle region) of these prior arts are merely a section of the naked shaft without spiral threads, whose only function is to contain debris. Whereas by having spirals threads with diminished outer diameter, or alternatively, by having rhombic threads, the 3^{rd} region thus configured possess triple functions—drilling, debris-containing, and securing, depending on different stages of screwing.

The present invention will become even more apparent to those of ordinary skilled in the art upon reading the following descriptions in conjunction with the accompanying drawings.

### BRIEF DESCRIPTION OF THE DRAWINGS

FIG. 1 is a perspective view illustrating a screw of the U.S. Pat. No. 6,966,737;

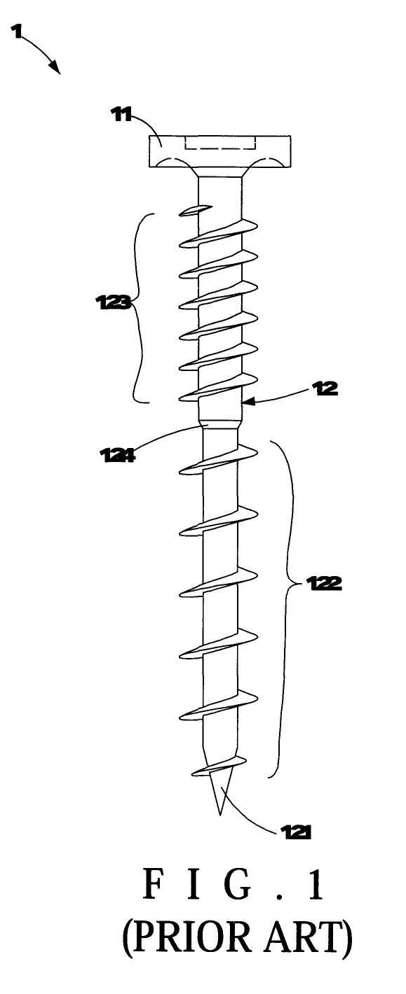

FIG. 2 is a perspective view illustrating a preferred embodiment of the present invention;

FIG. 3 is a perspective view illustrating the preferred embodiment in FIG. 2 in locking position; and

FIG. 4 is a perspective view illustrating a second preferred embodiment of the present invention.

### DETAILED DESCRIPTION OF THE PREFERRED EMBODIMENTS

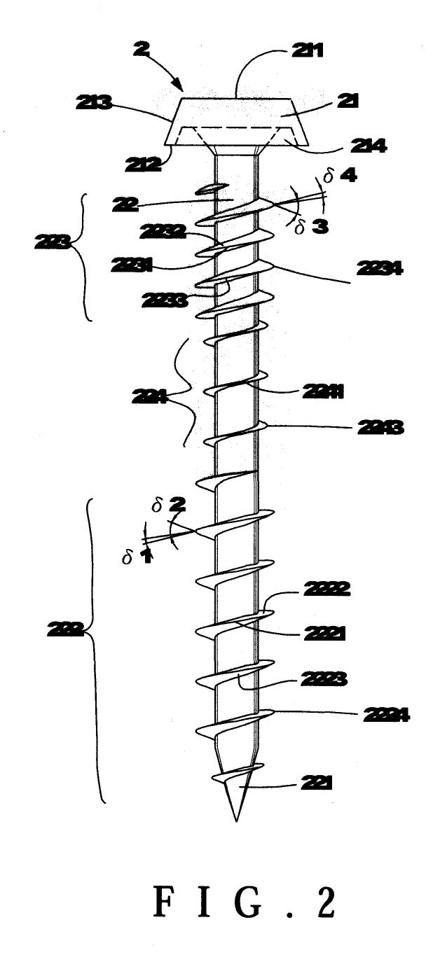

Referring to FIG. 2, the preferred embodiment of the present invention comprises a head 21 and a shank 22 engaging the head 21. The head 21 has a top surface 211, a bottom surface 212, and a periphery 213 disposed between the top surface 211 and the bottom surface 212. The bottom surface 212 is larger than the top surface 211. The head 21 forms an undercut 214 on the bottom surface 212; the periphery of the head 21 is inclined.

The ratio of the maximum outer diameter of the head 21 to that of the shank 22 is somewhere between 1.787:1 and 2.13:1. The shank 22 has a distal end 221, a 1^{st} region 222 disposed near the distal end 221, a 2^{nd} region 223 disposed near the head 21, and a 3^{rd} region 224 disposed between the 1^{st} region 222 and the 2^{nd} region 223. The 3^{rd} region 224 contains a plurality of threads spirally disposed on the shank 22. The threads 2221 of the 1^{st} region 222, the threads 2231 of the 2^{nd} region 223, and the threads 2241 of the 3^{rd} region 224 spiral in the same direction.

The number of threads per unit length in the 2^{nd} region 223 exceeds that in the 1^{st} region 222. The outer diameter of the 3^{rd} region 224 is smaller than that of the 1^{st} region 222 and the 2^{nd} region 223. The inner diameter of the 1^{st} region 222 equals to that of the 2^{nd} region 223. The number of threads per unit length in the 3^{rd} region 224 equals to that of threads per unit length in the 1^{st} region 222. Each thread 2221, 2231, and 2241 in the 1^{st} region 222, the 2^{nd} region 223, and the 3^{rd} region 224 forms a thread peak 2224, 2234, 2243, respectively.

Partial threads 2221 of the 1^{st} region 222 form a downward-inclined face 2222. The opposite partial threads 2221 form an upward-inclined face 2223. The size of the angle d1 (formed by the upward-inclined face 2223 and the thread peak 2224) is different from that of the angle d2 (formed by the downward-incline face 2222 and the thread peak 2224). To be more specific, the angle d1 formed (by the downward-inclined face 2222 and the thread peak 2224 is smaller than the angle d2 (formed by the downward-inclined face 2223 and the thread peak 2224).

Likewise, partial threads 2231 of the 2^{nd} thread region 223 form a downward-inclined face 2232; the opposite partial threads 2231 form an upward-inclined face 2233. The size of the angle d3 between the upward-inclined face 2233 and the thread peaks 2234 is different from that of the angle d4 (formed by the downward-inclined face 2232 and the thread peak 2234). To be more specific, the angle d3 (formed by the upward-inclined face 2233 and the thread peaks 2234) is larger than the angle d4 (formed by the downward-inclined face 2232 and the thread peak 2234).

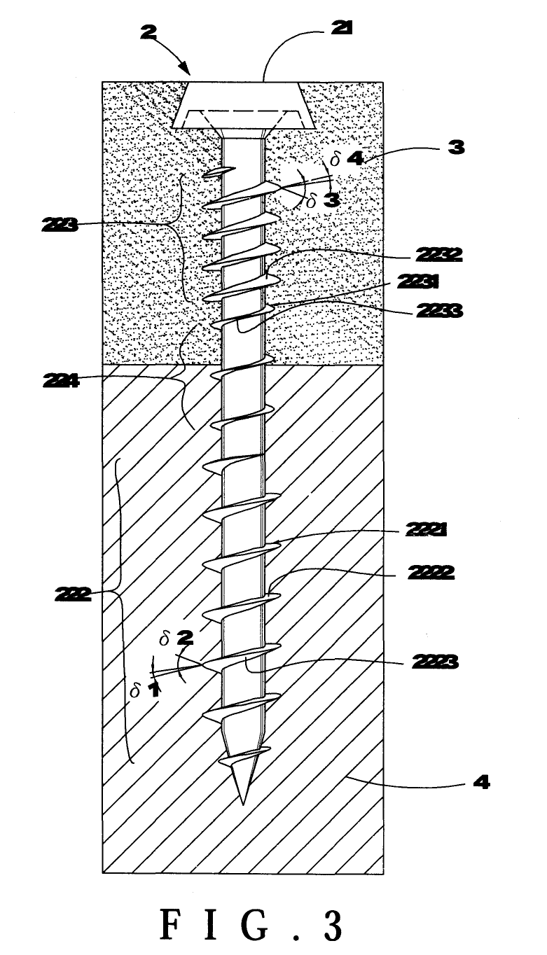

Referring to FIG. 3, while in operation, each thread region screws into a composite lumber 3 and a wood product 4 in order. Because the threads 2221 of the 1^{st} region 222, and the threads 2231 of the 2^{nd} region 223 all spiral in the same direction, the 2^{nd} region 223 will not extend the hole being screwed into. Due to the differences in size of the angle d1, d2, d3, and d4, the 2^{nd} region 223 will also be tightly screwed into the composite lumber 3, and the screw 2 will be rapidly screwed into the composite lumber 3 and the wood product 4.

With the outer diameter of the 3^{rd} region 224 being smaller than that of the 1^{st} region 222 and the 2^{nd} region 223, the room for containing debris in the 3^{rd} region 224 is augmented. When in operation, most debris will be pushed out rapidly with some debris accumulated in the spacious 3^{rd} region 224. This greatly reduces the resistance to screwing and speeds up the process.

Finally, with the head 21 being somewhat smaller and the periphery 213 of the head 21 being inclined, the screw 2 will sink into the composite lumber 3 in a fast and flat manner, keeping flatten the surface of the composite lumber 3.

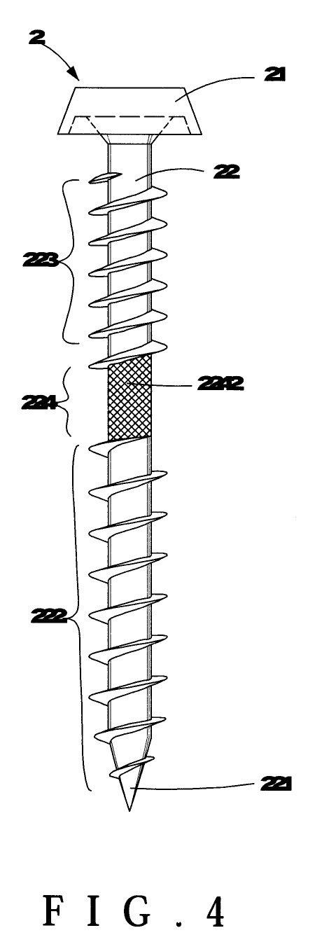

FIG. 4 shows a 2^{nd} preferred embodiment of the present invention. The differences between this embodiment and the first embodiment is that the 3^{rd} region 224 now being a plurality of rhombic threads 2242 disposed on the shank 22. This second embodiment achieves a very similar effect as the first embodiment. The spacious room formed by rhombic threads 2242 has a large capacity for containing debris. When in operation, the screw 2 fastens tightly with the object due to the rhombic threads 2242, which are surrounded by debris in all directions.

Having shown and described the embodiments in accordance with the present invention, it should be clear to those skilled in the art that further embodiments may be made without departing from the scope of the present invention.

I claim:

1. A screw comprising:
(1) a head, which comprises
a top surface,
a bottom surface, and
a periphery disposed between said top surface and said bottom surface; and
(2) a shank joining said head and comprising
a distal end,
a 1^{st} region with 1^{st}-region threads, each forming a thread peak and disposed near said distal end,
a 2^{nd} region with 2^{nd}-region threads, each forming a thread peak, spiraling in the same direction as said 1^{st}-region threads, and disposed near said head, wherein the number of said 2^{nd}-region threads per unit length exceeds that of said 1^{st}-region threads; and
a 3^{rd} region with a thread-equivalent structure, disposed between said 1^{st}-region and said 2^{nd}-region, serving mainly to contain debris and to secure said screw in place.

2. The screw of claim 1, wherein said thread-equivalent structure contains a plurality of spiral threads, each forming a thread peak and spiraling in the same direction as said 1^{st}-region threads and said 2^{nd}-region threads, of which the outer diameter is smaller than that of said 1^{st}-region threads and that of said 2^{nd}-region threads, and the number of said spiral threads per unit length does not exceed the number of 1^{st}-region threads.

3. The screw of claim 1, wherein said thread-equivalent structure is a plurality of rhombic threads.

4. The screw of claim 1, wherein partial threads of said 1^{st}-region threads and said 2^{nd}-region threads form a downward-inclined face, and the opposite partial threads of said 1^{st}-region threads and said 2^{nd}-region threads form an upward-inclined face, the angle formed by said upward-inclined face and said thread peak of said 1^{st}-region threads is different from the angle formed by said downward-inclined face and said thread peaks of said 1^{st}-region threads; the angle formed by said upward-inclined face and said thread peak of said 2^{nd}-region threads is different from the angle formed by said downward-inclined face and said thread peaks of said 2^{nd}-region threads.

5. The screw of claim 1, wherein the inner diameter of said 1^{st} region is the same as that of said 2^{nd} region.

6. The screw of claim 1, wherein said bottom surface is bigger than said top surface of said head, and the periphery of said head is inclined.

7. The screw of claim 6, wherein the ratio of the maximum outer diameter of said head to the outer diameter of said shank is between 1.787:1 and 2.13:1.
